(19) United States
(12) Patent Application Publication
(10) Pub. No.: US 2017/0351105 A1
(43) Pub. Date: Dec. 7, 2017

(54) THIN FILM WITH INTEGRATED GRATING AND POLARIZER, MANUFACTURING METHOD THEREOF, AND DISPLAY DEVICE

(71) Applicant: Wuhan China Star Optoelectronics Technology Co., Ltd., Wuhan (CN)

(72) Inventors: Hongqing CUI, Shenzhen (CN); Guowei ZHA, Shenzhen (CN)

(73) Assignee: Wuhan China Star Optoelectronics Technology Co., Ltd., Wuhan (CN)

(21) Appl. No.: 15/193,042

(22) Filed: Jun. 25, 2016

(30) Foreign Application Priority Data
Jun. 1, 2016 (CN) 2016103816379

(51) Int. Cl. G02B 27/22; G02B 5/18; B32B 37/14; G02B 27/26; G02B 5/30

(52) U.S. Cl. CPC G02B 27/2214; G02B 27/26; G02B 5/3033; B32B 37/14; G02B 5/1842; G02B 5/1866; B32B 2307/42

(57) ABSTRACT

The invention provides a thin film with integrated grating and polarizer. The thin film with integrated grating and polarizer includes a grating film and a polarizer film. The polarizer film is prepared on a light incident side of the grating film and thereby the grating film and the polarizer film are disposed integrally. By the above method, the invention can reduce film thickness and simplify manufacturing process.

### TECHNICAL FIELD

The invention relates to the field of display technology, and particularly to a thin film with integrated grating and polarizer, a manufacturing method thereof, and a display device.

### DESCRIPTION OF RELATED ART

Compared with the common 2D image display, the 3D technology can make an image become stereoscopic and realistic, as the image is no longer confined in the plane of a display screen. A naked-eye type 3D technology, getting rid of complex auxiliary equipments, is more close to the human way of viewing the world and therefore represents a development direction of new display technologies. A technology based on a slit grating, a cylindrical lens and a liquid crystal lens has become a mainstream mature 3D display technology. The cylindrical lens grating has advantages of simple preparation process and thin thickness, a thickness thereof only is about 200 μm, which can effectively reduce a height between the lens and a pixel and therefore is advantageous in fields of small-sized and high PPI (pixels per inch) 3D displays. The naked-eye 3D technology based on the cylindrical lens mainly depends upon subpixels' spatial division, a resolution is fallen by half with respect to the 2D display. A conventional and effective solution is to increase the resolution of a display device and reduce the size of pixel, which would require a smaller cylindrical lens focal length. However, a liquid crystal display panel needs to combine with a polarizer to achieve the naked-eye 3D effect, and a thickness of a traditional absorptive polarizer is about 100 μm. The naked-eye 3D display based on the cylindrical lens requires a series of bonding processes, such as bonding the polarizer on a display panel by an adhesive layer such as PSA (Pressure Sensitive Adhesive) and then bonding the cylindrical lens on the polarizer structure by another adhesive layer such as OCA (Optically Clear Adhesive). Therefore, two times bonding processes combined with heating, pressurizing and degassing processes are required. Moreover, since the adhesive such as OCA itself has a certain thickness, which objectively further increases a distance between a display pixel and the cylindrical lens and thus goes against high PPI naked-eye 3D display. In this situation, in order to decrease the distance, a process of thinning a glass substrate generally is employed, which on one hand would increase the cost, and on other hand would lead to an uncontrollable technical risk as thinner glass means more vulnerable and fragile.

Accordingly, there are needs of providing a thin film with integrated grating and polarizer, a manufacturing method thereof and a display device, so as to solve the above technical problems.

### SUMMARY

Technical problems mainly to be solved by the invention are to provide a thin film with integrated grating and polarizer, a manufacturing method thereof, and a display device, which can reduce film thickness in one aspect and can simplify manufacturing process in another aspect.

In order to solve the above technical problems, a technical solution proposed by the invention is to provide a thin film with integrated grating and polarizer. The thin film includes a grating film and a polarizer film, the polarizer film is prepared on a light incident side of the grating film and thereby the grating film and the polarizer film are disposed integrally.

In one embodiment, the polarizer film is prepared on the light incident side of the grating film by an attachment process, and no adhesive layer is provided between the polarizer film and the grating film.

In one embodiment, the polarizer film includes a polarizing PVA layer for generating polarized light and two protective layers respectively disposed on two surfaces of the polarizing PVA layer, one of the two protective layers is directly formed on the light incident side of the grating film.

In one embodiment, the polarizer film includes a polarizing PVA layer for generating polarized light and a protective layer disposed on a surface of the polarizing PVA layer away from the grating film, the polarizing PVA layer is directly formed on the light incident side of the grating film.

In one embodiment, the polarizing PVA layer and the protective layer(s) are combined together by a lamination process.

In one embodiment, an adhesive layer is disposed on a surface of the polarizer film away from the grating film, an adhesive protective layer is disposed on a surface of the adhesive layer away from the grating film, the adhesive protective layer is peelably disposed on the adhesive layer, and the adhesive layer is used for bonding with a display panel. The grating film is a cylindrical lens grating film, and the light incident side is a non-curved side of the cylindrical lens grating film.

In order to solve the technical problems, another technical solution proposed by the invention is to provide a display device. The display device includes a display panel, a backlight module for providing backlight to the display panel, and a thin film with integrated grating and polarizer disposed on a light emitting surface of the display panel. The thin film with integrated grating and polarizer is any one of above described thin films.

In order to solve the technical problems, still another technical solution proposed by the invention is to provide a manufacturing method of a thin film with integrated grating and polarizer. The manufacturing method includes: preparing a grating film; and preparing a polarizer film on a light incident side of the grating film to obtain a thin film with integrated grating and polarizer.

In one embodiment, the step of preparing a polarizer film on a light incident side of the grating film to obtain a thin film with integrated grating and polarizer film includes: preparing the polarizer film on the light incident side of the grating film by an attachment process, wherein no adhesive layer is provided between the polarizer film and the cylindrical lens grating film.

In one embodiment, the step of preparing the polarizer film on the light incident side of the grating film by an attachment process includes: laminating a polarizing PVA layer for generating polarized light and two protective layer respectively disposed on two surfaces of the polarizing PVA layer together to form the polarizer film, and meanwhile making the grating film and the polarizer film be laminated together as a whole; or sequentially laminating a first protective layer, a polarizing PVA layer for generating polarized light and a second protective layer on the light incident side of the grating film; or laminating a polarizing PVA layer for generating polarized light and a protective layer disposed on a surface of the polarizing PVA layer away from the grating film together to form the polarizer film, and meanwhile making the grating film and the polarizer film be laminated together as a whole; or sequentially laminating a polarizing PVA layer for generating polarized light and a protective layer on the light incident side of the grating film.

The efficacy achieved by the invention is that: distinguishing from the situation in the prior art, the thin film of the invention includes a grating film and a polarizer film, the polarizer film is prepared on the light incident side of the grating film, the grating film and the polarizer film are disposed integrally, and therefore there is no need of glue layer between the grating film and the polarizer film, which can reduce the overall thickness of the film, eliminate processes such as heating, pressurizing and degassing and thus simplify the manufacturing process.

### BRIEF DESCRIPTION OF THE DRAWINGS

FIG. 1 is a schematic structural view of a thin film with integrated grating and polarizer according to a first embodiment of the invention.

FIG. 2 is a schematic structural view of a thin film with integrated grating and polarizer according to a second embodiment of the invention.

FIG. 3 is a schematic structural view of a display device according to an embodiment of the invention.

FIG. 4 is a flowchart of a manufacturing method of a thin film with integrated grating and polarizer according to a preferred embodiment of the invention.

### DETAILED DESCRIPTION OF EMBODIMENTS

In order to make technical problems to be solved, technical solutions and beneficial effects of the invention be more clear and apparent, in the following, in conjunction with accompanying drawings and embodiments, the invention will be further described in detail. It should be understood that, specific embodiments described herein are merely to illustrate the invention and not intended to limit the invention.

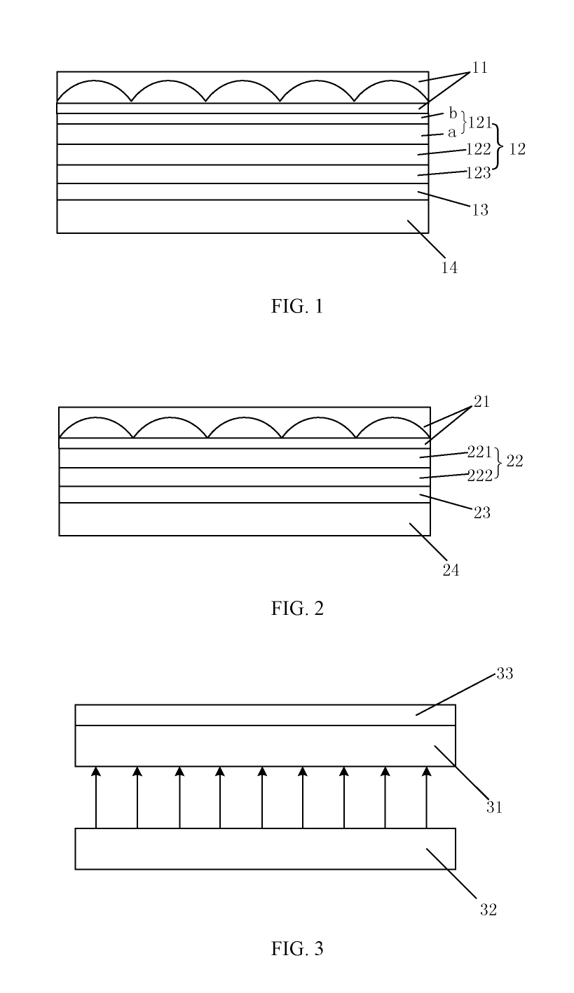

Referring to FIG. 1, which is a schematic structural view of a thin film with integrated grating and polarizer according to a first embodiment of the invention. In the illustrated embodiment, the thin film with integrated grating and polarizer includes a grating film 11 and polarizer film 12. The polarizer film 12 is directly prepared on a light incident side of the grating film 11 and thereby the grating film 11 and the polarizer film 12 are disposed as a whole, i.e., generally the grating film 11 and the polarizer film 12 are disposed in contact with each other.

Preferably, the grating film 11 is a cylindrical lens grating film, the light incident side is a side of the cylindrical lens grating film being non-curved surface, i.e., the bottom side as shown in the drawing. In other embodiment, the grating film 11 may be a slit grating film, a liquid crystal grating film, or other grating film can achieve the naked-eye 3D function instead.

Preferably, the polarizer film 12 of the thin film with integrated grating and polarizer is prepared on the light incident side of the grating film 11 by attachment process, and no adhesive layer is disposed between the polarizer film 12 and the grating film 11. In particular, the grating film 11 and the polarizer film 12 are directly laminated together as a whole by a lamination technique of attachment process, rather than bonded together through an adhesive layer.

Preferably, the polarizer film 12 includes a polarizing PVA (i.e., polyvinyl alcohol or vinylalcohol polymer) layer 122 for generating polarized light and two protective layers 121, 123 respectively disposed on two surfaces of the polarizing PVA layer. The two protective layers 121, 123 respectively are the first protective layer 121 disposed on a surface of the polarizing PVA layer 122 adjacent to the grating film 11 and the second protective layer 123 disposed on a surface of the polarizing PVA layer 122 away from the grating film 11. The first protective layer 121 is directly formed on the light incident side of the grating film 11 to contact with the grating film 11. The first protective layer 121 and the grating film 11 are directly laminated together as a whole by a lamination technique of attachment process rather than bonded together by an adhesive layer. Preferably, the first protective layer 121 includes a first protective layer main body a and a surface protective film b disposed on a surface of the protective layer main body a adjacent to the grating film 11. The surface protective film b may include an anti-reflective layer, an anti-scratch layer, an anti-glare layer, a hard coat layer and etc. In other embodiment, the first protective layer 121 may not include the surface protective film, so as to further reduce the thickness of the thin film.

Preferably, the polarizing PVA layer 122 and the first protective layer 121 are combined with each other by a lamination technique. The polarizing PVA layer 122 and the second protective layer 123 are combined with each other by a lamination technique.

Preferably, an adhesive layer 13 is disposed on a surface of the polarizer film 12 away from the grating film 11, an adhesive protective layer 14 is disposed on a surface of the adhesive layer 13 away from grating film 11, the adhesive layer 14 is peelably disposed on the adhesive layer 13, and the adhesive layer 13 is used for bonding with a display panel. The adhesive layer 13 preferably is an optically clear adhesive (OCA) layer.

The preparation of the thin film with integrated grating and polarizer includes two situations, that is, after preparing the grating film 11, the first situation is that the first protective layer 121, the polarizing PVA layer 122 and the second protective layer 123 are sequentially stacked on the light incident side of the grating film 11, and then all are laminated together and therefore just one laminating action is needed; the second situation is that the first protective layer 121, the polarizer PVA layer 122 and the second protective layer 123 sequentially are laminated on the light incident side of the grating film 11, and therefore three laminating actions are needed. Afterwards, the adhesive layer 13 is coated on the surface of the polarizer film 12 away from grating film 11, and the adhesive layer 13 preferably is an optically clear adhesive layer, and then the adhesive protective layer 14 is attached/pasted on the adhesive layer 13. When in use, the adhesive protective layer 14 is peeled from the adhesive layer 13 and then the thin film with integrated grating and polarizer is attached onto a light emitting surface of a display panel.

In the present embodiment, since the grating film and the polarizer film are integrated as a whole, the polarizer film is directly prepared on the light incident side of the grating film, a glue layer between the grating film and the polarizer film can be omitted/eliminated, which on one hand can reduce the thickness of the film so that the thin film is more light and thin and thus the display device is more light and thin consequently, and on other hand can eliminate processes such as heating, pressurizing and degassing and thereby simplify the production process resulting from there is no need of glue layer for attachment.

Referring to FIG. 2, which is a schematic structural view of a thin film with integrated grating and polarizer according to a second embodiment of the invention. In the illustrated embodiment, the thin film with integrated grating and polarizer includes a grating film 21 and a polarizer film 22. The polarizer film 22 is directly prepared on a light incident side of the grating film 21 and thereby the grating film 21 and the polarizer film 22 are disposed integrally, i.e., generally the grating film 21 and the polarizer film 22 are disposed in contact with each other.

Preferably, the grating film 21 is a cylindrical lens grating film, the light incident side is a non-curved side of the cylindrical lens grating film. In other embodiment, the grating film 21 may be a slit grating film or a liquid crystal grating film.

Preferably, the thin film with integrated grating and polarizer is prepared on the light incident side of the grating film by an attachment process, and the polarizer film 22 and the grating film 21 are not provided an adhesive layer therebetween. The polarizer film 22 and the grating film 21 particularly are directly combined/laminated together as a whole by a lamination technique in the attachment process rather than bonded together through an adhesive layer.

Preferably, the polarizer film 22 includes a polarizing PVA layer 221 for generating polarized light and a protective layer 222 disposed on a surface of the polarizer PVA layer 221 away from the grating film 21, and the polarizing PVA layer 221 is directly formed on the light incident side of the grating film 21 to contact with the grating film 21. The polarizing PVA layer 221 and the grating film 21 are directly combined/laminated together as a whole by a lamination technique of an attachment process rather than bonded together by an adhesive layer.

Preferably, the polarizing PVA layer 221 and the protective layer 222 are combined with each other by a lamination technique.

Preferably, an adhesive layer 23 is disposed on a surface of the polarizer film 22 away from the grating film 21, an adhesive protective layer 24 is disposed on a surface of the adhesive layer 23 away from grating film 21, the adhesive layer 24 is peelably disposed on the adhesive layer 23, and the adhesive layer 23 is used for bonding with a display panel. The adhesive layer 23 preferably is an optically clear adhesive layer.

The preparation of the thin film with integrated grating and polarizer includes two situations, that is, after the preparation of the grating film 21, the first situation is that the polarizing PVA layer 221 and the protective layer 122 are sequentially stacked on the light incident side of the grating film 21 and then all are laminated together, and thus just one laminating action is needed; the second situation is that the polarizing PVA layer 221 and the protective layer 222 are sequentially laminated on the light incident side of the grating film 21, and thus two laminating actions are needed. Afterwards, the adhesive layer 23 is coated on the surface of the polarizer film 22 away from grating film 21, the adhesive layer 23 preferably is an optically clear adhesive layer, and then the adhesive protective layer 24 is attached/pasted on the adhesive layer 23. When in use, the adhesive protective layer 24 is peeled from the adhesive layer 23 and then the thin film with integrated grating and polarizer is attached onto a light emitting surface of a display panel.

In the present embodiment, compared with the first embodiment, one protective layer is omitted, and the grating film directly acts as a protective layer at one side of the polarizing PVA layer, which further reduces the thickness of the thin film with integrated grating and polarizer.

Referring to FIG. 3, which is a schematic structural view of a display device according to the invention. In the illustrated embodiment, the display device includes a display panel 31, a backlight module 32 for providing backlight to the display panel 31, and a thin film 33 with integrated grating and polarizer disposed on a light emitting surface of the display panel 31. The thin film 33 with integrated grating and polarizer is the thin film with integrated grating and polarizer according to any one of above described embodiments.

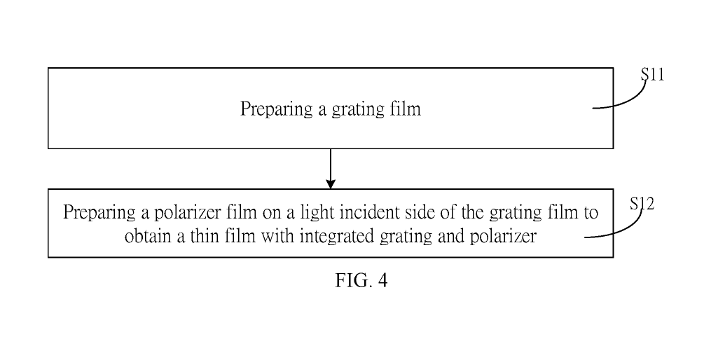

Referring to FIG. 4, which is a flowchart of a manufacturing method of a thin film with integrated grating and polarizer according to a preferred embodiment of the invention. In the illustrated embodiment, the manufacturing method of the thin film with integrated grating and polarizer includes the following steps S11 and S12.

Step S11, preparing a grating film.

In the step S11, the grating film is a cylindrical lens grating film. In other embodiment, the grating film may be a slit grating film or a liquid crystal grating film instead.

Step S12, preparing a polarizer film on a light incident side of the grating film to obtain a thin film with integrated grating and polarizer.

In the step S12, the light incident side is a side of the cylindrical lens grating film being non-curved surface. In particular, preparing a polarizer film on a light incident side of the grating film to obtain a thin film with integrated grating and polarizer specifically includes: preparing the polarizer film on the light incident side of the grating film by an attachment process, and there is no adhesive layer being disposed between the polarizer film and the cylindrical lens grating film.

More specifically, the step of preparing the polarizer film on the light incident side of the grating film by an attachment process can be classified into following four situations.

The first situation includes: laminating a polarizing PVA layer for generating polarized light and two protective layers respectively disposed on two surfaces of the polarizing PVA layer together to form the polarizer film, and meanwhile making the grating film and the polarizer film be laminated together as a whole.

The second situation includes: sequentially laminating a first protective layer, a polarizing PVA layer for generating polarized light and a second protective on the light incident side of the grating film.

The third situation includes: laminating a polarizing PVA layer for generating polarized light and a protective layer disposed on a surface of the polarizing PVA layer away from the grating film together to form the polarizer film, and meanwhile making the grating film and the polarizer film be combined/laminated together as a whole.

The fourth situation includes: sequentially laminating a polarizing PVA layer for generating polarized light and a protective layer on the light incident side of the grating film.

Preferably, the protective layer may include an anti-reflective layer, an anti-scratch layer, anti-glare layer, a hard coat layer and etc. In other embodiment, the protective layer may include other layer.

After the step S12, the manufacturing method may further include: disposing an adhesive layer on a surface of the polarizer film away from the grating film; and disposing an adhesive protective layer on a surface of the adhesive layer away from the grating film. For example, an adhesive layer is firstly coated on the surface of the polarizer film away from the grating film, and the adhesive layer preferably is an optically clear adhesive layer, and then an adhesive protective layer is pasted on the adhesive layer.

When in use, the adhesive protective layer is peeled from the adhesive layer, and then the thin film with integrated grating and polarizer is attached onto a light emitting surface of a display panel. After the adhesive protective layer at the bottom of the thin film with integrated grating and polarizer is peeled off, the thin film is bonded with the display panel by a bonding platform and then a degassing process is performed.

The thin film of the invention includes a grating film and a polarizer film, the polarizer film is prepared on the light incident side of the grating film, the grating film and the polarizer film are disposed as a whole, and therefore the glue layer (adhesive layer) between the grating film and the polarizer film can be eliminated, which can reduce the overall thickness of the film, eliminate the processes such as heating, pressurizing and pressure degassing, and simplify the manufacturing process as a result.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A thin film with integrated grating and polarizer, comprising:
a grating film and a polarizer film; wherein the polarizer film is prepared on a light incident side of the grating film and thereby the grating film and the polarizer are disposed as a whole;
wherein the thin film with integrated grating and polarizer further comprises an adhesive layer and an adhesive protective layer; the adhesive layer is disposed on a surface of the polarizer film away from the grating film, the adhesive protective layer is peelably disposed on a surface of the adhesive layer away from the polarizer film;
wherein the adhesive protective layer is peeled from the adhesive layer when the thin film with integrated grating and polarizer is used in a display device where the thin film with integrated grating and polarizer is attached onto a light emitting surface of a display panel through the adhesive layer.

2. The thin film as claimed in claim 1, wherein the polarizer film is prepared on the light incident side of the grating film by an attachment process, and no adhesive layer is disposed between the polarization film and the grating film.

3. The thin film as claimed in claim 1, wherein the polarizer film comprises a polarizing polyvinyl alcohol (PVA) layer for generating polarized light and two protective layers respectively located on two surfaces of the polarizing PVA layer, and one of the two protective layers is immediately formed on the light incident side of the grating film.

4. The thin film as claimed in claim 1, wherein the polarizer film comprises a polarizing polyvinyl alcohol (PVA) layer for generating polarized light and a protective layer located on a surface of the polarizing PVA layer away from the grating film, the polarizing PVA layer is immediately formed on the light incident side of the grating film.

5. The thin film as claimed in claim 3, wherein the polarizing PVA layer and the protective layer(s) are combined together by a lamination technique.

6. The thin film as claimed in claim 1, wherein the grating film is a cylindrical lens grating film, and the light incident side is a non-curved side of the cylindrical lens grating film.

7. A display device comprising a display panel, a backlight module for providing backlight to the display panel, and a thin film with integrated grating and polarizer disposed on a light emitting surface of the display panel; wherein the thin film with integrated grating and polarizer is the thin film as claimed in claim 1 of which the adhesive protective layer is peeled from the adhesive layer.

8. A manufacturing method of a thin film with integrated grating and polarizer, wherein the manufacturing method comprises:
preparing a grating film;
preparing a polarizer film on a light incident side of the grating film;
disposing an adhesive layer on a surface of the polarizer film away from the grating film; and
disposing an adhesive protective layer on a surface of the adhesive layer away from the polarizer film to thereby obtain a thin film with integrated grating and polarizer;
wherein the adhesive protective layer is peelable and is peeled from the adhesive layer when the thin film with integrated grating and polarizer is used in a display device.

9-10. (canceled)

11. The thin film as claimed in claim 1, wherein the adhesive layer is an optically clear adhesive (OCA) layer.

12. The display device as claimed in claim 7, wherein the adhesive layer is an optically clear adhesive (OCA) layer.

13. The display device as claimed in claim 7, wherein the display device achieves a naked-eye 3D display resulting from the thin film with integrated grating and polarizer.

14. The manufacturing method as claimed in claim 8, wherein the adhesive layer is an optically clear adhesive (OCA) layer.

15. The manufacturing method as claimed in claim 8, wherein the step of preparing a polarizer film on a light incident side of the grating film comprises:
sequentially stacking a first protective layer, a polarizing polyvinyl alcohol (PVA) layer for generating polarized light and a second protective layer on the light incident side of the grating film in that order and then laminating the grating film, the first protective layer, the polarizing PVA layer and the second protective layer together in that order by one lamination action.

16. The manufacturing method as claimed in claim 8, wherein the step of preparing a polarizer film on a light incident side of the grating film comprises:
sequentially laminating a first protective layer, a polarizing polyvinyl alcohol (PVA) layer for generating polarized light and a second protectively on the light incident side of the grating film by three lamination actions so that the grating film, the first protective layer, the polarizing PVA layer and the second protective layer are sequentially laminated together in that order.

17. The manufacturing method as claimed in claim 8, wherein the step of preparing a polarizer film on a light incident side of the grating film comprises:
sequentially stacking a polarizing polyvinyl alcohol (PVA) layer for generating polarized light and a protective layer on the light incident side of the grating film in that order and then laminating the grating film, the polarizing PVA layer and the protective layer together in that order by one lamination action.

18. The manufacturing method as claimed in claim 8, wherein the step of preparing a polarizer film on a light incident side of the grating film comprises:
sequentially laminating a polarizing polyvinyl alcohol (PVA) layer for generating polarized light and a protective layer on the light incident side of the grating film by two lamination actions so that the grating film, the polarizing PVA layer and the protective layer are laminated together in that order.
